(19) United States
(12) Patent Application Publication
(10) Pub. No.: US 2007/0155332 A1
(43) Pub. Date: Jul. 5, 2007

(54) Method and mobile communication device for characterizing an audio accessory for use with the mobile communication device

(76) Inventors: John M. Burgan, North Palm Beach, FL (US); Scott M. Garrett, Weston, FL (US); Jose E. Korneluk, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/323,527

(22) Filed: Dec. 30, 2005

(51) Int. Cl. H04B 17/00

(52) U.S. Cl. 455/67.11; 455/556.1; 455/73

(57) ABSTRACT

A mobile communication device (100) is attached to an audio accessory (114, 124) and characterizes the audio response of the audio accessory. Upon detecting attachment to the mobile communication device (204), the mobile communication device plays an audio test regimen over the speaker of the audio accessory (210, 212, 214, 216, 218, 220). Once the audio accessory's spectral response is known, the mobile communication device may adjust audio processing filter coefficients used in processing audio signals played over the audio accessory.

### TECHNICAL FIELD

This invention relates in general to mobile communication devices, and more particularly to audio accessories for use with mobile communication devices.

### BACKGROUND OF THE INVENTION

Mobile communication devices are increasingly used for a variety of application other than just voice communication. It is now common for mobile communication devices to support text messaging, internet browsing, gaming, satellite positioning, and music playing, for example. Audio files, such as music, are commonly stored in MPEG layer 3 (mp3) encoded form. As memory prices continue to drop, the ability of mobile communication devices to carry and play audio files is becoming a market focus. Attention is being given to the quality at which portable devices can play music and other audio files. Present mobile communication devices are typically digital, and accordingly have a fairly powerful digital signal processor that allows good audio signal processing. However, audio accessories that have been made for mobile communication devices have lagged in audio quality because they are typically designed with only conventional telephony voice quality in mind. Processing audio files, such as decoding mp3 files, consumes precious battery life. If an audio accessory is incapable of producing an acoustic version of the file with sufficient fidelity, than the mobile communication device may be wasting battery life. Typically the audio response of transducers such as earpieces are known at the time of manufacture, and the known audio response can be used by the mobile communication device in processing audio files and signals. However, when, for example, a third party aftermarket accessory is connected to the mobile communication device, the mobile communication device has no way of processing audio information in a way that is optimized of the audio accessory and battery life. Therefore there is a need for a way in which an audio accessory may be characterized for use with a mobile communication device.

### BRIEF DESCRIPTION OF THE DRAWINGS

FIG. 1 shows a block schematic diagram of a mobile communication device, in accordance with an embodiment of the invention; and

FIG. 2 shows a flow chart diagram of a method of characterizing an audio accessory for use with a mobile communication device, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. The invention solves the problem of using an audio accessory with an unknown spectral response by using the digital signal processor of the mobile communication device to generate test tones at different power levels, playing the tones through the audio accessory, and measuring the response at the microphone of the mobile communication device. Once the spectral response of the audio accessory has been characterized, the mobile communication device can process audio information to be played over the audio accessory accordingly.

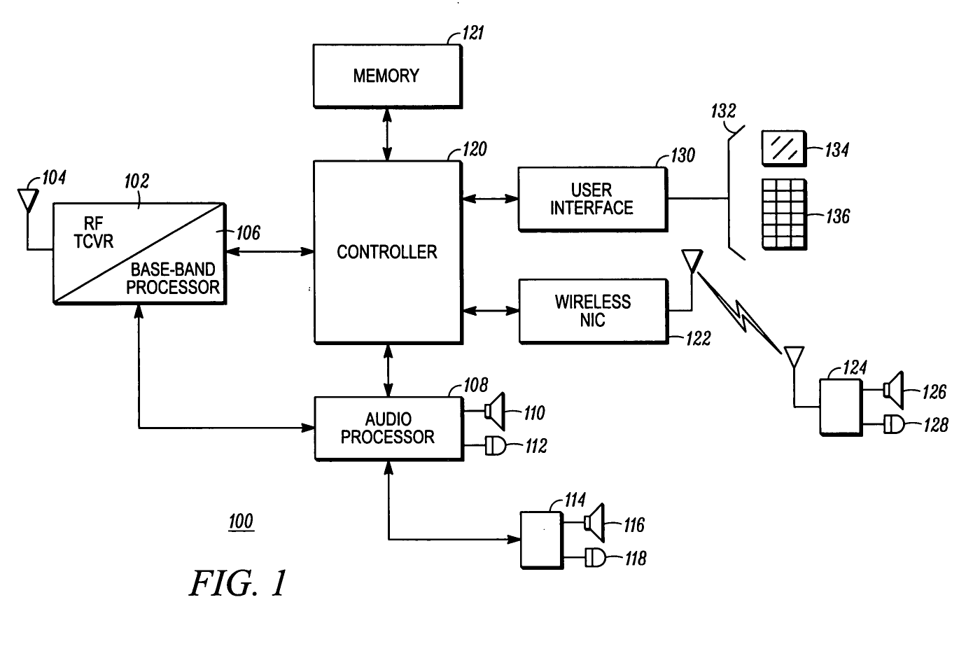

Referring now to FIG. 1, there is shown a block schematic diagram 100 of a mobile communication device, in accordance with an embodiment of the invention. The mobile communication device comprises a radio frequency (RF) transceiver 102 coupled to an antenna 104. The RF transceiver performs radio frequency operations, such as modulation and demodulation, amplification, and filtering of signals to be transmitted and received over the antenna. The RF transceiver is coupled to a baseband processor 106 which processes digital information to be transmitted by, and received from the RF transceiver. The baseband processor comprises a digital signal processor that can generate digital signals, perform digital filtering, power measurements, correlations, convolutions, and so on. The baseband processor is coupled to an audio processor 108. The audio processor converts analog signals produced by a microphone 112 into digital signals to be passed to the baseband processor. The audio processor further receives digital audio from the baseband processor and converts it to an analog signal to be played over a speaker 110 such as an earpiece. An audio accessory 114 may be coupled to the mobile communication device such as by an audio jack, as is known. The audio accessory has a speaker 116 and may have a microphone 118. The audio accessory may be, for example, a stereo headphone set, or a telephone headset. Although shown here as being coupled to the audio processor, there are a variety of arrangements that are equivalent. The mobile communication device is primarily controlled by a controller 120 which includes a microprocessor which execute instruction code stored in a memory 121. The memory may be an aggregate memory and include a variety of memory types, such as read only memory, random access memory, flash memory, volatile and non-volatile memory. For example, in one embodiment instruction code may be stored in a flash memory, and upon starting up the mobile communication device, the instruction code may be copied to a random access memory for execution. The controller supervises operation of the mobile communication device, and provides resources for subsystems of the mobile communication device. For example, the mobile communication device may further comprise a local wireless network interface core 122 for wirelessly communicating with similarly equipped devices in close proximity to the mobile communication device. For example, a wireless audio accessory 124 may be wirelessly coupled to the mobile communication device. The wireless audio accessory may be a wireless headset including a speaker 126 and microphone 128. Alternatively it may be a stereo headset with two speakers, one for each channel. The controller further operates a user interface 130. The user interface is a collection of circuits and instruction code which allow the mobile communication device to interact with the user, receive commands and input from the user, as well as provide information and prompts to the user. The user interface includes some primary elements 132 including, for example, a graphical display 134 and a keypad 136. The keypad may include a conventional telephone keypad in addition to other buttons.

The mobile communication device is able to detect attachment of an audio accessory, such as audio accessory 114 or wireless audio accessory 124. Upon detection of the audio accessory, the controller may prompt the user to test the audio accessory's spectral response, which is performed by the user holding the speaker of the audio accessory near the microphone of the mobile communication device while the mobile communication device plays a test regimen of sounds over the audio accessory's speaker. As the speaker produces sound, the mobile communication device evaluates the sound by digitizing the signal produced by the microphone. If the mobile communication device is to provide music playing functionality, the audio processor 108 must be able to sample at a much higher rate than is used for conventional telephony. Furthermore, the microphone spectral response must be known. Typically the microphone spectral response can be tested at the time of manufacture, and the spectral profile stored in the memory 121 of the mobile communication device. Alternatively, a general spectral response may be used on the assumption that the microphone used is a mass produced article and the variation in spectral response from one to another is minimal. As the test regimen is played, the baseband processor 106 may be used to measure the response magnitude and the amount of distortion produced. The baseband processor may adjust the raw signal in view of the known microphone spectral response to determine the audio accessory spectral response.

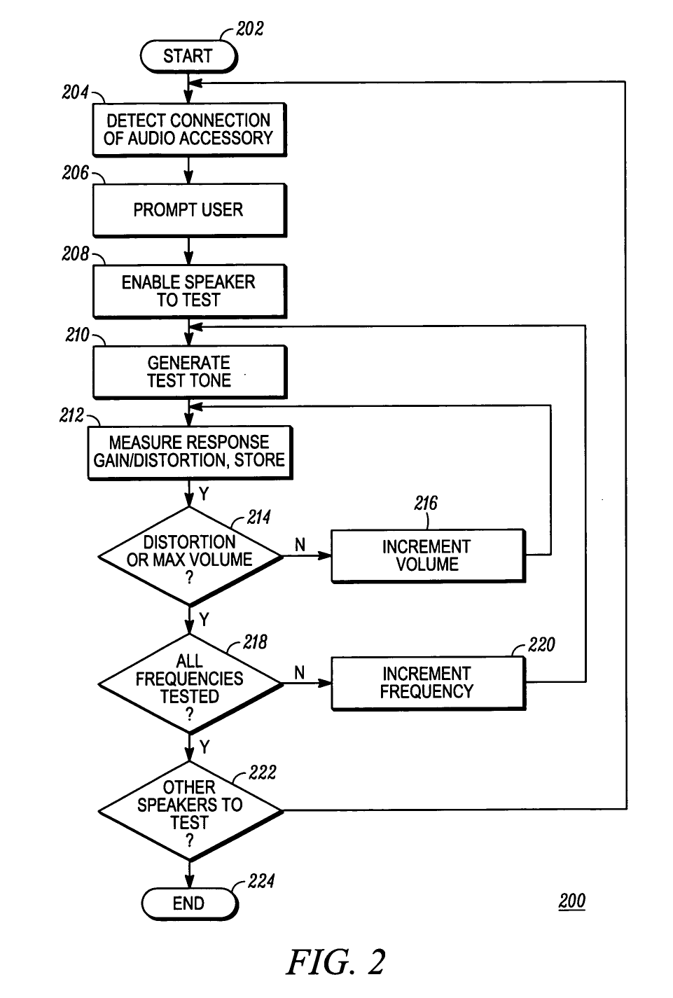

Referring now to FIG. 2, there is shown a flow chart diagram 200 of a method of characterizing an audio accessory for use with a mobile communication device, in accordance with an embodiment of the invention. At the start 202 the mobile communication device is powered on and operating normally. Thereafter the user of the mobile communication device attaches an audio accessory, such as a head set or wireless earpiece, for example. The mobile communication device detects the attachment of the audio accessory 204. Detecting the attachment may be performed in a conventional manner, such as detecting the insertion of an audio plug into an audio jack of the mobile communication device, or by detecting the association of a wireless audio accessory with the local wireless interface of the mobile communication device. Upon detecting the attachment of the audio accessory, the mobile communication device may attempt to identify the audio accessory to automatically select, for example, a set of equalizer coefficients to be used for processing audio signals to be played over the audio accessory. If the audio accessory can not be identified, the mobile communication device may prompt the user 206 to initiate the audio test regimen to characterize the audio accessory's spectral response. The prompting may be performed, for example, by displaying a message on a graphical display of the mobile communication device, or generating an alert tone, or both. The prompting may also include waiting for an input to be received from the user before commencing with the process. Upon being prompted, the user must hold a speaker portion of the audio accessory near the microphone of the mobile communication device. It is contemplated that an audio shroud may be used between the speaker of the audio accessory and the microphone to help isolate the speaker and maintain a known distance from the microphone. Once the audio accessory is positioned near the microphone the mobile communication device enables the audio accessory's speaker 208 by setting the audio path. The mobile communication device then begins the audio test regimen. The audio test regimen may comprise playing a plurality of tones at different frequencies and repeating those tones at different volume or power levels. Thus, the mobile communication device may commence the process by generating a test tone 210 played over the audio accessory's speaker. The mobile communication device uses the microphone to measure the response 212, which is stored n the mobile communication device. Both the gain and distortion may be characterized. Upon completing the measurement, the mobile communication device checks to see if the speaker distortion is excessive, or if the present tone amplitude is at a maximum setting 214. If the tone amplitude generated by the mobile communication device is not at a maximum and if the speaker being tested is not distorting the tone, the mobile communication device increments the amplitude 216 and repeats at the same frequency. Once the maximum amplitude of the present frequency has been tested, or if the distortion at the present frequency and amplitude is excessive, the mobile communication device checks to see if there are more frequencies to test 218. If so, then the frequency generation is incremented 220 to the next frequency to be tested and the process repeats for different amplitude settings. It is contemplated that frequency increments may be linear, or logarithmic, or corresponding to an auditory perception scale. As all the frequencies are tested, an audio accessory spectral response is produced, which is stored in the memory of the mobile communication device for later use. As the audio testing regimen commences, there may be frequencies where the audio accessory speaker gain is below a preselected threshold. This may occur above or below certain frequencies as well as at bands in mid-frequency ranges. When these frequencies are identified, they can be avoided when decoding some audio media, such as mp3 files.

Once the speaker has been tested, the mobile communication device may prompt the user to determine if there are other speakers to be tested 222, such as in a stereo headset, and if so, the method may be repeated for the additional speaker. Although, it is contemplated that, since the speakers in a stereo headset are matched, their response may not substantially deviate. Thus, the spectral response of once speaker may be assumed to be the same for another speaker of the audio accessory. Once the process is complete of for the speakers being tested, the process terminates 224. The stored response produced in block 212 is produced in view of the known microphone spectral response, and may be used to generate equalizer coefficients, as well as, for example, selectively decode audio files that have been encoded by frequency, such as mp3 files.

Thus, the invention provides a method for characterizing an audio accessory for use with a mobile communication device. The mobile communication device comprises a microphone, which has a microphone spectral response stored in a memory of the mobile communication device. The method is performed by the mobile communication device and commences upon detecting an attachment of the audio accessory to the mobile communication device. Once the audio accessory is detected, the mobile communication device commences by prompting the user of the mobile communication device to initiate testing of the audio accessory. The testing commences by playing an audio test regimen over the audio accessory. Meaning, audio signals are provided to the audio accessory over the connection to be played over a speaker of the audio accessory. The mobile communication device then commences measuring audio parameters with the microphone while playing the audio test regimen. The audio parameters may include amplitude and distortion, for example. The mobile communication device then proceeds by processing the audio parameters in view of the microphone spectral response to provide an audio accessory spectral response. If the audio accessory includes two speakers for stereo operation, the playing may be performed over only one speaker on the assumption that both speakers are substantially similar and will have a similar response. Playing the audio regimen may include playing a plurality of tones, each of the plurality of tones repeated at a plurality of power levels. By adjusting power or amplitude levels, the mobile communication device can determine if the speaker being tested suffers from distortion at higher volumes. Measuring the audio parameters may therefore include measuring amplitude and distortion of each of the plurality of tones for the different volume settings. Once the audio accessory spectral response is determined, the mobile communication device may adjust audio output coefficients based on the audio accessory spectral response. That is, the coefficients may be used to normalize equalizer settings to provide a desired response for the user of the mobile communication device. Detecting attachment of the audio accessory may include detecting attachment of a wireless audio accessory over a local wireless link. The method may also include receiving an input from the user after prompting the user and playing the audio test regimen may then be performed in response to receiving the input.

The invention may also provide a mobile communication device including an audio accessory connection for connecting an audio accessory to the mobile communication device. The audio accessory connection may be, for example, an audio jack or a local wireless interface. The audio accessory has a speaker for playing audio signals from the mobile communication device. The mobile communication device further includes a microphone that has a known microphone spectral response. Further, the mobile communication device includes a means for generating the audio test regimen to be played over the speaker of the audio accessory, and a means for measuring the audio accessory spectral response of the audio accessory at the microphone of the mobile communication device. Once the audio accessory spectral response in measured, the mobile communication device may store the response in a memory. The means for generating the audio test regimen may include a baseband processor of the mobile communication device used in mobile communications. The means for generating the audio test regimen further may also include an audio processor of the mobile communication device for converting digital signals generated by the baseband processor to analog signals to be played over the speaker of the audio accessory. The means for measuring the audio accessory spectral response may likewise include the baseband processor of the mobile communication device, and the audio processor for converting analog signals generated by the speaker of the audio accessory to digital signals which are provided to the baseband processor. The memory of the mobile communication device may include instruction code for operating the mobile communication device to detect attachment of the audio accessory to the mobile communication device, and to prompt a user of the mobile communication device to initiate testing of the audio accessory, as well as to process audio signals to be played over the audio accessory in accordance with the audio accessory spectral response.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for characterizing an audio accessory for use with a mobile communication device, the mobile communication device comprising a microphone having a microphone spectral response, the microphone spectral response stored in a memory of the mobile communication device, the method performed by the mobile communication device and comprising:
detecting attachment of an audio accessory to the mobile communication device;
prompting a user of the mobile communication device to initiate testing of the audio accessory;
playing an audio test regimen over the audio accessory;
measuring audio parameters with the microphone while playing the audio test regimen;
processing the audio parameters in view of the microphone spectral response to provide an audio accessory spectral response.

2. A method for characterizing an audio accessory as defined in claim 1, wherein the audio accessory includes two speakers for stereo operation, the playing is performed over only one speaker.

3. A method for characterizing an audio accessory as defined in claim 1, wherein playing the audio regimen comprises playing a plurality of tones, each of the plurality of tones repeated at a plurality of power levels.

4. A method for characterizing an audio accessory as defined in claim 3, wherein measuring audio parameters comprises measuring amplitude and distortion of each of the sequence of tones.

5. A method for characterizing an audio accessory as defined in claim 1, further comprising adjusting audio output coefficients of the mobile communication device based on the audio accessory spectral response.

6. A method for characterizing an audio accessory as defined in claim 1, wherein detecting attachment of the audio accessory comprises detecting attachment of a wireless audio accessory over a local wireless link.

7. A method for characterizing an audio accessory as defined in claim 1, further comprising receiving an input from the user after prompting the user and wherein the playing the audio test regimen is performed in response to receiving the input.

8. A mobile communication device, comprising:
an audio accessory connection for connecting an audio accessory to the mobile communication device, the audio accessory having a speaker for playing audio signals from the mobile communication device;
a microphone having a known microphone spectral response;
means for generating an audio test regimen to be played over the speaker of the audio accessory;
means for measuring an audio accessory spectral response of the audio accessory at the microphone of the mobile communication device; and
a memory for storing the audio accessory spectral response.

9. A mobile communication device as defined in claim 8, wherein the means for generating the audio test regimen includes a baseband processor of the mobile communication device.

10. A mobile communication device as defined in claim 8, wherein the means for measuring the audio accessory spectral response includes a baseband processor of the mobile communication device.

11. A mobile communication device as defined in claim 9, wherein the means for generating the audio test regimen further comprises an audio processor of the mobile communication device for converting digital signals generated by the baseband processor to analog signals to be played over the speaker of the audio accessory.

12. A mobile communication device as defined in claim 10, wherein the means for measuring the audio accessory spectral response further comprises an audio processor of the mobile communication device for converting analog signals generated by the speaker of the audio accessory to digital signals which are provided to the baseband processor.

13. A mobile communication device as defined in claim 8, wherein the memory of the mobile communication device comprises instruction code for operating the mobile communication device to detect an attachment of the audio accessory to the mobile communication device, and to prompt a user of the mobile communication device to initiate testing of the audio accessory.

14. A mobile communication device as defined in claim 8, further comprising a local wireless network interface core for wirelessly coupling to the audio accessory.

15. A mobile communication device as defined in claim 8, wherein the memory of the mobile communication device comprises instruction code for operating the mobile communication device to, process audio signals to be played over the audio accessory in accordance with the audio accessory spectral response.

16. A mobile communication device as defined in claim 8, wherein the memory of the mobile communication device comprises instruction code for operating the mobile communication device to selectively decode an audio file to avoid decoding frequencies of the audio file at which an audio accessory gain is insufficient as indicated by the audio accessory spectral response.
